(19) United States
(12) Patent Application Publication
(10) Pub. No.: US 2026/0141766 A1
(43) Pub. Date: May 21, 2026

(54) SEPARATE AUXILIARY DIGITAL LOCK STRUCTURE

(71) Applicant: MH HOLDINGS USA CORP., Newark, DE (US)

(72) Inventor: MING-HUNG CHEN, Taipei (TW)

(21) Appl. No.: 18/951,665

(22) Filed: Nov. 19, 2024

(51) Int. Cl. G07C 9/00

(52) U.S. Cl. CPC G07C 9/00944; G07C 9/00309; G07C 2009/00634

(57) ABSTRACT

A separate auxiliary digital lock structure includes: a panel device mounted on an outer side of the door panel and having at least one trigger module and a wireless signal transmission module, the trigger module generating and sending an unlocking trigger signal to the wireless signal transmission module; and a latch device mounted on an inner side of the door panel and having at least one latch control module, a wireless signal receiving module and a lock module, the wireless signal receiving module receiving and sending the unlocking trigger signal to the latch control module, allowing the latch control module to controllably cause the lock module to separate from a door frame. The separate auxiliary digital lock structure can be installed on the door panel yet still keeps the door panel intact. The panel device and latch device are attached to the door panel and perform wireless signal transmission.

### FIELD

The present disclosure relates to a separate auxiliary digital lock structure capable of being quickly installed and performing unlocking through wireless signal transmission.

### BACKGROUND

A door lock is a required element for every door panel and is intended to ensure household security. Indoor door locks and outdoor door locks in wide use nowadays are mostly key-based mechanical locks. Owing to the inconvenience of using physical keys, digital locks are becoming more popular with home owners. However, the installation of a digital lock on a door panel not only entails creating a receiving space in the door panel to allow a circuit of the digital lock and related hardware to be placed inside the receiving space but also requires mounting the digital lock on a door lock support with screws or any other hand tools. Therefore, the installation of conventional digital locks has to be carried out by qualified technicians. Nevertheless, some home owners are interested in changing their mechanical door locks to digital locks without having the receiving spaces created in their door panels, and thus these home owners remain hesitated to go for digital locks.

Therefore, there is still room for improvement in the prior art.

### SUMMARY

In view of the aforesaid drawbacks of the prior art, it is an objective of the disclosure to provide a separate auxiliary digital lock structure capable of being quickly installed and performing unlocking through wireless signal transmission.

Another objective of the disclosure is to provide a separate auxiliary digital lock structure that can be installed on a door panel yet still keeps the door panel intact.

To achieve the above and other objectives, the disclosure provides a separate auxiliary digital lock structure, adapted to be mounted on a door panel, comprising: a panel device mounted on an outer side of the door panel and having at least one trigger module and a wireless signal transmission module, the trigger module generating and sending an unlocking trigger signal to the wireless signal transmission module; and a latch device mounted on an inner side of the door panel and having at least one latch control module, a wireless signal receiving module and a lock module, the wireless signal receiving module receiving and sending the unlocking trigger signal to the latch control module, allowing the latch control module to controllably cause the lock module to separate from a door frame.

Regarding the separate auxiliary digital lock structure in an embodiment of the disclosure, the panel device further comprises a panel power supply module electrically connected to the trigger module.

Regarding the separate auxiliary digital lock structure in an embodiment of the disclosure, the latch device further comprises a latch power supply module electrically connected to the latch control module.

Regarding the separate auxiliary digital lock structure in an embodiment of the disclosure, the latch device further comprises a handle connected to the latch control module, and the latch control module controllably causes the lock module to separate from the door frame.

Regarding the separate auxiliary digital lock structure in an embodiment of the disclosure, the latch device further comprises a sensing module sensing spaced apart from a baffle at a top of the door frame by a distance.

The separate auxiliary digital lock structure in an embodiment of the disclosure further comprises a driving device mounted on the inner side of the door panel, the driving device having at least one driving control module and a wireless signal communication module, the wireless signal communication module receiving and sending the unlocking trigger signal to the driving control module, the driving control module receiving, reading and sending the unlocking trigger signal to the wireless signal communication module, the wireless signal communication module sending the unlocking trigger signal to the wireless signal receiving module, the wireless signal receiving module receiving and sending the unlocking trigger signal to the latch control module, allowing the latch control module to controllably cause the lock module to separate from the door frame.

Regarding the separate auxiliary digital lock structure in an embodiment of the disclosure, the driving device further comprises a driving power supply module electrically connected to the driving control module.

Regarding the separate auxiliary digital lock structure in an embodiment of the disclosure, the latch device further comprises a wired signal receiving module in electrical connection with the latch control module, and the driving device further comprises a wired signal communication module in signal electrical connection with the wired signal receiving module and the driving control module, the driving control module receiving, reading and sending the unlocking trigger signal to the wired signal communication module, the wired signal communication module sending the unlocking trigger signal to the wired signal receiving module, the wired signal receiving module receiving and sending the unlocking trigger signal to the latch control module, allowing the latch control module to controllably cause the lock module to separate from the door frame.

### BRIEF DESCRIPTION OF THE DRAWINGS

FIG. 1 is a schematic view of a separate auxiliary digital lock structure assembled according to the disclosure.

FIG. 2 is a block diagram of the separate auxiliary digital lock structure of the disclosure.

FIG. 3 is a block diagram of how to implement the separate auxiliary digital lock structure of the disclosure.

FIG. 4 is another schematic view of the separate auxiliary digital lock structure assembled according to the disclosure.

FIG. 5 is another block diagram of the separate auxiliary digital lock structure of the disclosure.

FIG. 6 is another block diagram of how to implement the separate auxiliary digital lock structure of the disclosure.

FIG. 7 is another schematic view of how to implement the separate auxiliary digital lock structure of the disclosure.

FIG. 8 is another schematic view of the assembled separate auxiliary digital lock structure with a sensing module according to the disclosure.

FIG. 9 is another block diagram of the separate auxiliary digital lock structure with a speech function according to the disclosure.

FIG. 10 is another block diagram of the separate auxiliary digital lock structure of the disclosure.

### DETAILED DESCRIPTION

The aforesaid objectives, structural features, and functional features of the disclosure are depicted by accompanying drawings, illustrated by a preferred embodiment, and described below.

The structural and technical features of separate auxiliary digital lock structure of the disclosure are illustrated by a preferred embodiment, depicted by accompanying drawings, and described below. However, the disclosure is certainly not restricted to the embodiment, accompanying drawings or description.

Persons skilled in the art understand that both the embodiment and the accompanying drawings are exemplary and illustrative rather than restrictive of the disclosure. All inventions accomplished by making simple modifications or changes to the embodiment according to the description must be regarded as not departing from the spirit and scope of the disclosure and thus regarded as falling within the scope of the claims of the disclosure.

Directional expressions, such as “above,” “below,” “left,” “right,” “front” and “back,” used in the embodiment described below must be interpreted in accordance with the accompanying drawings. Therefore, the directional expressions are illustrative rather than restrictive of the disclosure. In the embodiment described below, identical or similar components are denoted by identical or similar reference numerals.

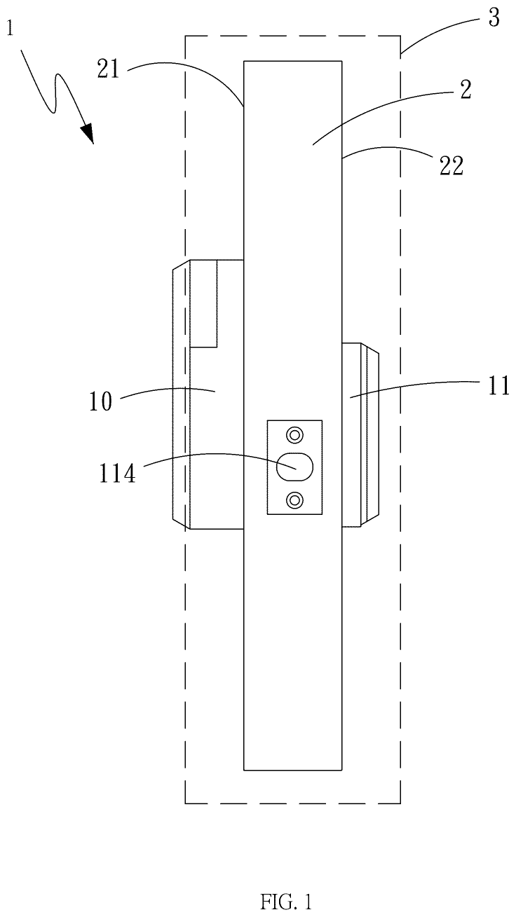

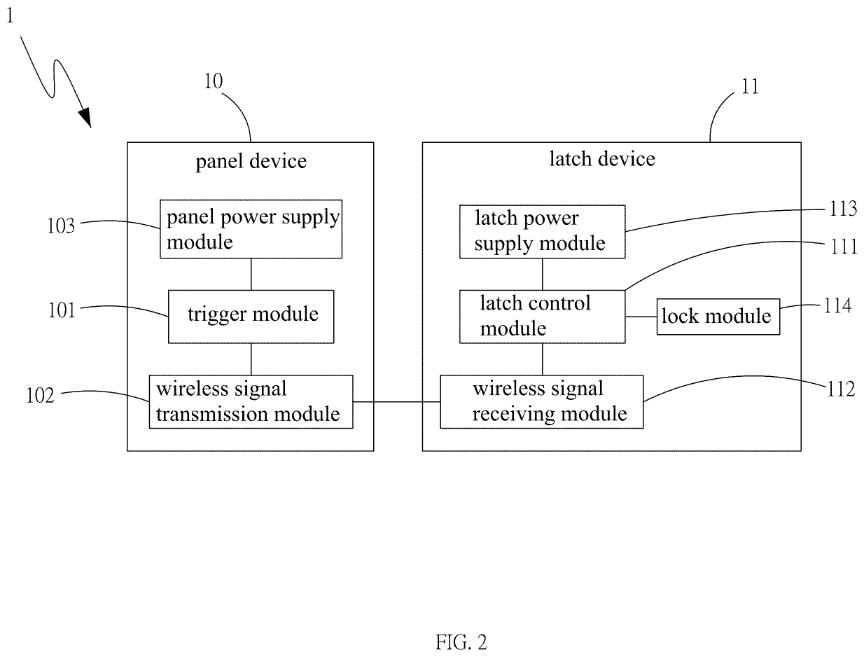

Referring to FIG. 1 and FIG. 2, there are shown a schematic view and a block diagram of a separate auxiliary digital lock structure 1 assembled according to the disclosure. As shown in the diagrams, the separate auxiliary digital lock structure 1 is mounted on a door panel 2. The separate auxiliary digital lock structure 1 comprises a panel device 10 and a latch device 11.

The panel device 10 is attached to an outer side 21 of the door panel 2. The panel device 10 comprises a trigger module 101, a wireless signal transmission module 102 and a panel power supply module 103. The trigger module 101 controls a trigger panel. The trigger panel is in signal connection with the wireless signal transmission module 102. The wireless signal transmission module 102 is a Bluetooth signal emitter. The trigger panel is further electrically connected to the panel power supply module 103. The panel power supply module 103 is a battery for supplying electric power to the trigger module 101 and the wireless signal transmission module 102.

The latch device 11 is attached to an inner side 22 of the door panel 2. The latch device 11 comprises at least one latch control module 111, a wired signal receiving module 119, a driving power supply module 123 and a lock module 114. The latch control module 111 is provided in the number of two in this embodiment; thus, if one of the two modules malfunctions while the latch device 11 is operating, the other module will substitute for the malfunctioning model. The latch control module 111 is in signal connection with the wired signal receiving module 119 and the lock module 114. The wired signal receiving module 119 is a Bluetooth signal receiver. The latch control module 111 is further electrically connected to the latch power supply module 113. The latch power supply module 113 is a battery for supplying electric power to the latch control module 111, the wired signal receiving module 119 and the lock module 114. The lock module 114 is a lock object capable of undergoing displacement. The lock module 114 and the latch device 11 are separated or fitted together.

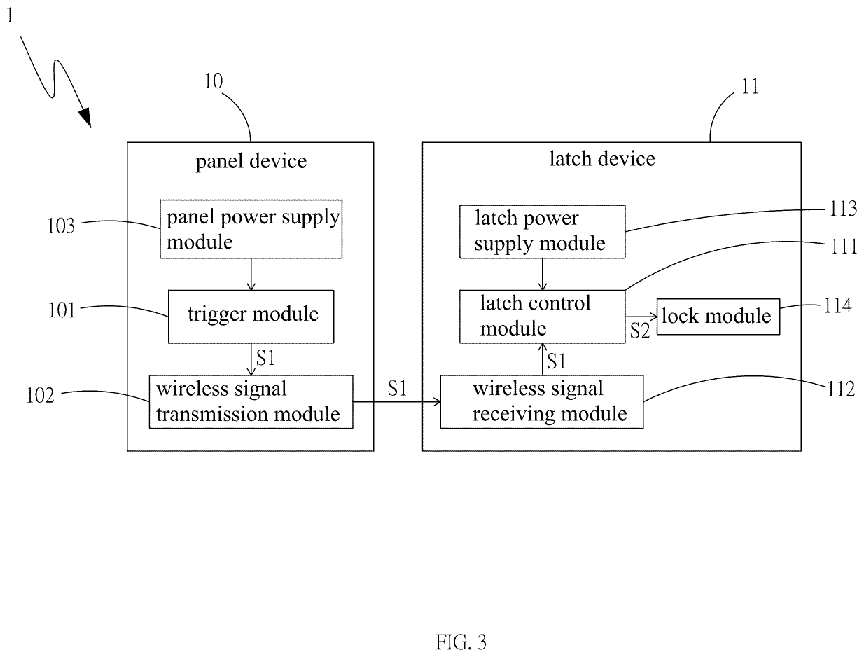

Referring to FIG. 3, there is shown a block diagram of how to implement the separate auxiliary digital lock structure of the disclosure. As shown in the diagram, upon the attachment of the panel device 10 to the outer side 21 of the door panel 2 and the attachment of the latch device 11 to the inner side 22 of the door panel 2, the wireless signal transmission module 102 of the panel device 10 and the wired signal receiving module 119 of the latch device 11 are connected by wireless Bluetooth signals. The latch control module 111 controllably causes the lock module 114 to move to the door frame 3, allowing the door panel 2 and a door frame 3 to interlock through the lock module 114. As shown in the diagram which depicts this embodiment, the lock module 114 is disposed inside the door panel 2. Alternatively, the lock module 114 is fitted to the latch device 11 and attached to the inner side 22 of the door panel 2 from behind.

To start performing an unlocking process on the panel device 10, a user uses the trigger module 101 to trigger the unlocking process by generating and sending an unlocking trigger signal S1 to the wireless signal transmission module 102. The wireless signal transmission module 102 wirelessly transmits the unlocking trigger signal S1 to the wired signal receiving module 119. After receiving the unlocking trigger signal S1, the wired signal receiving module 119 sends the unlocking trigger signal S1 to the latch control module 111 such that the latch control module 111 generates a control signal S2 that controllably causes the lock module 114 to separate from the door frame 3. Thus, the separate auxiliary digital lock structure 1 can be installed on the door panel 2 yet still keeps the door panel 2 intact. The panel device 10 and the latch device 11 are not only attached to the outer side 21 and the inner side 22 of the door panel 2 directly but also perform wireless signal transmission, allowing the separate auxiliary digital lock structure 1 to be capable of being quickly installed and performing unlocking through wireless signal transmission.

The wireless signal transmission relation between the panel device 10 and the latch device 11. The wireless signal transmission module 102 of the panel device 10 generates the unlocking trigger signal S1 through the trigger module 101. The wired signal receiving module 119 of the latch device 11 regularly and continuously receives signals sent from the wireless signal transmission module 102.

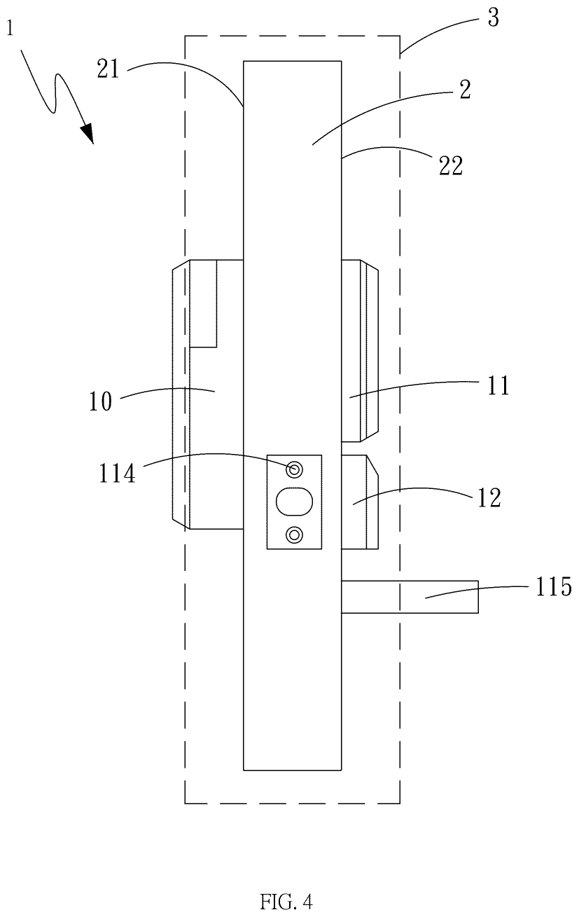

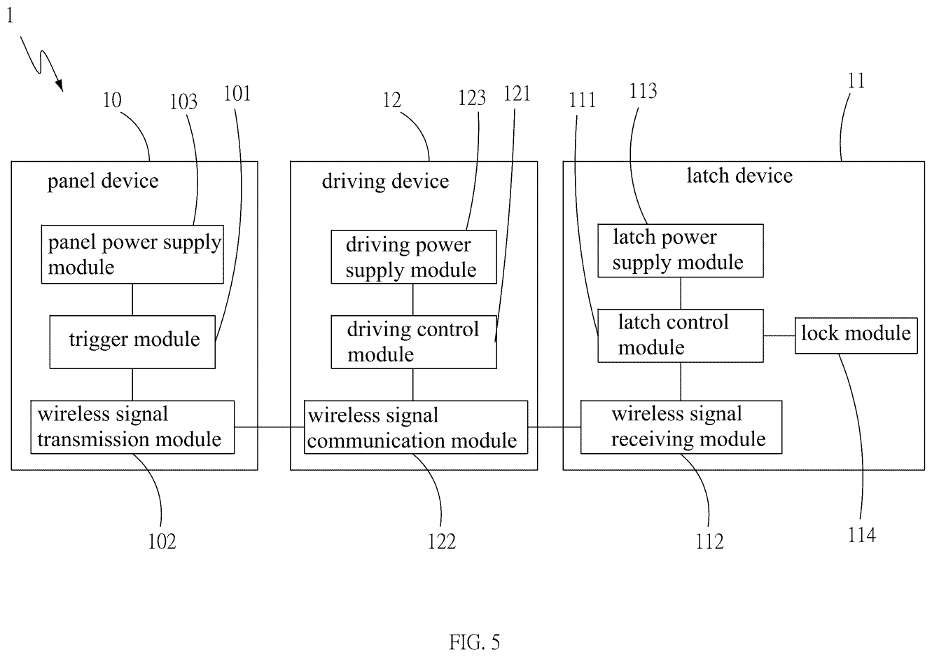

Referring to FIG. 4 and FIG. 5, there are shown another schematic view and another block diagram of the separate auxiliary digital lock structure assembled according to the disclosure. As shown in the diagrams, the separate auxiliary digital lock structure 1 further comprises a driving device 12. The driving device 12 is attached to the inner side 22 of the door panel 2. The driving device 12 and the panel device 10 are linearly aligned. The driving device 12 comprises at least one driving control module 121, a wireless signal communication module 122 and a driving power supply module 123. The driving power supply module 123 is provided in the number of two in this embodiment; thus, if one of the two modules malfunctions while the driving device 12 is operating, the other module will substitute for the malfunctioning model. The wireless signal communication module 122 is in signal connection with the wireless signal transmission module 102 and the wired signal receiving module 119. The wireless signal communication module is a Bluetooth signal communicator. The driving control module 121 is further electrically connected to the driving power supply module 123. The driving power supply module 123 is a battery for supplying electric power to the driving control module 121 and the wireless signal communication module 122.

The latch device 11 further comprises a handle 115 connected to the latch control module 111.

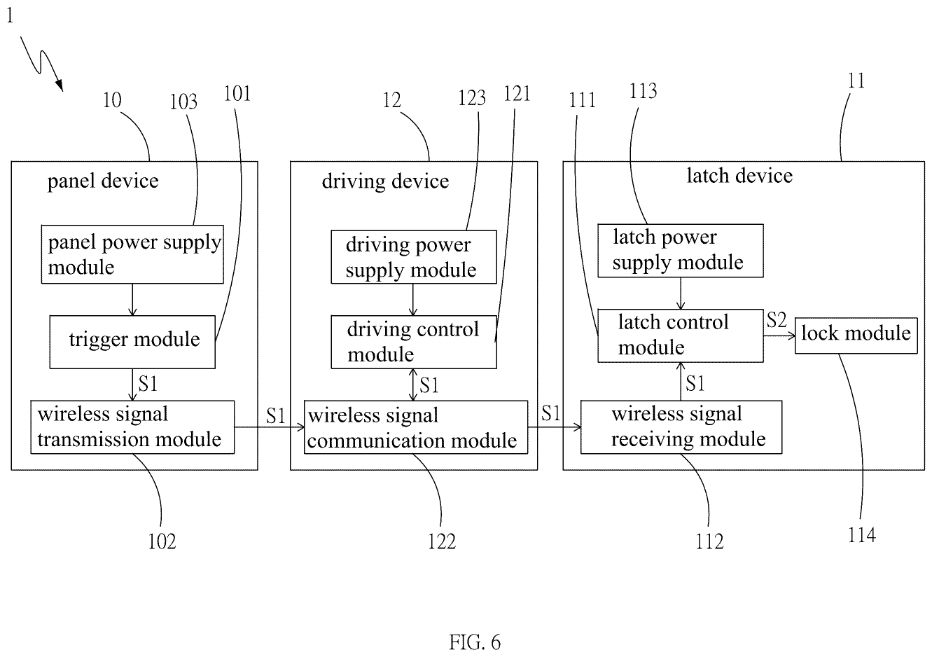

Referring to FIG. 6, there is shown another block diagram of how to implement the separate auxiliary digital lock structure of the disclosure. As shown in the diagram, upon the attachment of the panel device 10 to the outer side 21 of the door panel 2 and the attachment of the driving device 12 and the latch device 11 to the inner side 22 of the door panel 2, not only are the wireless signal transmission module 102 of the panel device 10 and the wireless signal communication module 122 of the driving device 12 connected by wireless Bluetooth signals, but the wireless signal communication module 122 of the driving device 12 and the wired signal receiving module 119 of the latch device 11 are also connected by wireless Bluetooth signals. The latch control module 111 controllably causes the lock module 114 to move to the door frame 3, allowing the door panel 2 and the door frame 3 to interlock through the lock module 114. To start performing an unlocking process on the panel device 10, the user uses the trigger module 101 to trigger the unlocking process by generating and sending the unlocking trigger signal S1 to the wireless signal transmission module 102. The wireless signal transmission module 102 wirelessly transmits the unlocking trigger signal S1 to the wireless signal communication module 122. After receiving the unlocking trigger signal S1, the wireless signal communication module 122 sends the unlocking trigger signal S1 to the driving control module 121. The driving control module 121 receives and reads the unlocking trigger signal S1. When the driving control module 121 determines that the unlocking trigger signal S1 is a correct unlocking signal, the driving control module 121 sends the unlocking trigger signal S1 to the wireless signal communication module 122. Then, the wireless signal communication module 122 sends the unlocking trigger signal S1 to the wired signal receiving module 119. The wired signal receiving module 119 sends the unlocking trigger signal S1 to the latch control module 111, allowing the latch control module 111 to generate the control signal S2 that controllably causes the lock module 114 to separate from the door frame 3. Thus, the separate auxiliary digital lock structure 1 can be installed on the door panel 2 yet still keeps the door panel 2 intact. The panel device 10 and the latch device 11 are not only attached to the outer side 21 and the inner side 22 of the door panel 2 directly but also perform wireless signal transmission, allowing the separate auxiliary digital lock structure 1 to be capable of being quickly installed and performing unlocking through wireless signal transmission.

When the user operates the handle 115 from the inner side 22 of the door panel 2 with a view to opening the door panel 2, the latch control module 111 senses the rotation or movement of the handle 115 and thus generates the control signal S2 that controllably causes the lock module 114 to separate from the door frame 3.

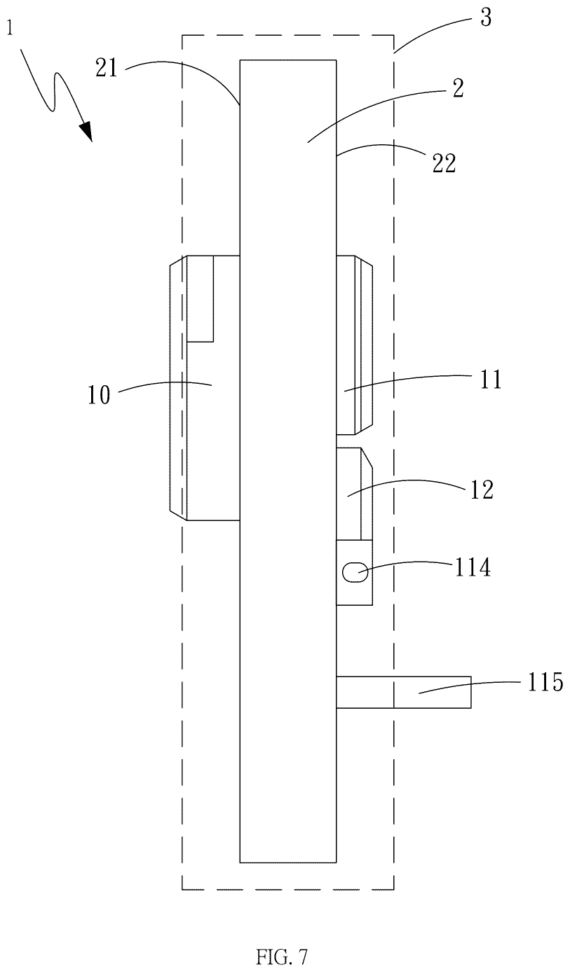

Referring to FIG. 7, there is shown another schematic view of how to implement the separate auxiliary digital lock structure of the disclosure. In this embodiment, the lock module 114 is either disposed inside the door panel 2 or fitted to the driving device 12, depending on the types of the door panel 2 and the door frame 3. For instance, the lock module 114 is disposed inside the door panel 2 that is of a general style but fitted to the door panel 2 and the driving device 12 and attached to the inner side 22 of the door panel 2 from behind when the door panel 2 is of a Japanese style. The latch control module 111 controllably causes the lock module 114 to move to the door frame 3, allowing the door panel 2 and the door frame 3 to interlock through the lock module 114. To start performing an unlocking process, the user uses the trigger module 101 to trigger the unlocking process by generating and sending the unlocking trigger signal S1 to the wireless signal transmission module 102. The wireless signal transmission module 102 wirelessly transmits the unlocking trigger signal S1 to the wireless signal communication module 122. After receiving the unlocking trigger signal S1, the wireless signal communication module 122 sends the unlocking trigger signal S1 to the driving control module 121. The driving control module 121 receives and reads the unlocking trigger signal S1. When the driving control module 121 determines that the unlocking trigger signal S1 is a correct unlocking signal, the driving control module 121 sends the unlocking trigger signal S1 to the wireless signal communication module 122. Then, the wireless signal communication module 122 sends the unlocking trigger signal S1 to the wired signal receiving module 119. The wired signal receiving module 119 sends the unlocking trigger signal S1 to the latch control module 111 such that the latch control module 111 generates the control signal S2 that controllably causes the lock module 114 to separate from the door frame 3. Thus, the separate auxiliary digital lock structure 1 can be installed on the door panel 2 yet still keeps the door panel 2 intact. The panel device 10 and the latch device 11 are not only attached to the outer side 21 and the inner side 22 of the door panel 2 directly but also perform wireless signal transmission, allowing the separate auxiliary digital lock structure 1 to be capable of being quickly installed and performing unlocking through wireless signal transmission.

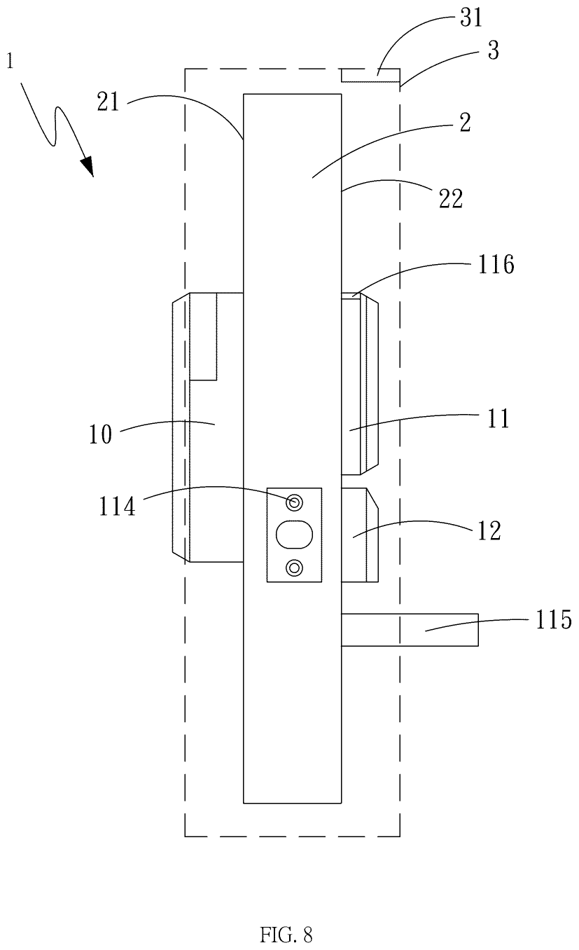

Referring to FIG. 8, there is shown another schematic view of the assembled separate auxiliary digital lock structure with a sensing module according to the disclosure. As shown in the diagram, the latch device 11 further comprises a sensing module 116, and a baffle 31 is disposed at the top of the door frame 3. The sensing module 116 is a laser ranging module or a solenoid valve sensing module. In this embodiment, the sensing module 116 is exemplified by a laser ranging module. The sensing module is electrically connected to the latch control module 111, and its sensing distance from the baffle 31 is determined by laser. The sensing distance is set by the latch control module 111; thus, the sensing module 116 continuously illuminates the baffle 31 while the door panel 2 is shut, but the sensing module 116 cannot illuminate the baffle 31 while the door panel 2 is opened. If the latch control module 111 determines that the sensing module has not illuminated the baffle 31 by a time limit, the latch control module 111 will wirelessly send an alert signal to the user's smartphone to cause an app installed on the smartphone to display thereon an alert message about the door panel 2 not being properly shut.

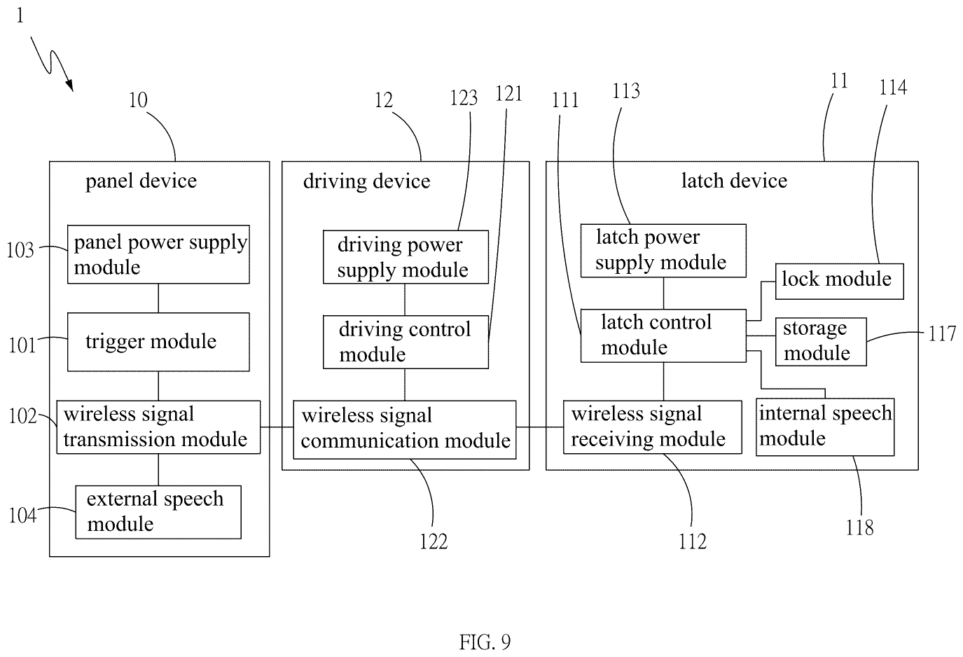

Referring to FIG. 9, there is shown another block diagram of the separate auxiliary digital lock structure with a speech function according to the disclosure. As shown in the diagram, the panel device 10 further comprises an external speech module 104, whereas the latch device 11 further comprises a storage module 117 and an internal speech module 118. The storage module 117 stores therein a sensing code database corresponding to a plurality of sensing cards. To start performing an unlocking process on the panel device 10 with the sensing cards, the users use the trigger module 101 to trigger the unlocking process by generating and sending the unlocking trigger signal S1 to the wireless signal transmission module 102. The wireless signal transmission module 102 wirelessly transmits the unlocking trigger signal S1 to the wireless signal communication module 122. After receiving the unlocking trigger signal S1, the wireless signal communication module 122 sends the unlocking trigger signal S1 to the driving control module 121. The driving control module 121 receives and reads the unlocking trigger signal S1. When the driving control module 121 determines that the unlocking trigger signal S1 conforms with the sensing database of the storage module 117, the driving control module 121 determines that the unlocking trigger signal S1 is a correct unlocking signal. The driving control module 121 sends the unlocking trigger signal S1 to the wireless signal communication module 122. Then, the wireless signal communication module 122 sends the unlocking trigger signal S1 to the wired signal receiving module 119. The wired signal receiving module 119 sends the unlocking trigger signal S1 to the latch control module 111 such that the latch control module 111 generates the control signal S2 that controllably causes the lock module 114 to separate from the door frame 3. Thus, the separate auxiliary digital lock structure 1 can be installed on the door panel 2 yet still keeps the door panel 2 intact. The panel device 10 and the latch device 11 are not only attached to the outer side 21 and the inner side 22 of the door panel 2 directly but also perform wireless signal transmission, allowing the separate auxiliary digital lock structure 1 to be capable of being quickly installed and performing unlocking through wireless signal transmission.

The external speech module 104 of the panel device 10 and the internal speech module 118 of the latch device 11 are a microphone and a loudspeaker respectively. Thus, a cross-door conversation takes place between the panel device 10 and the latch device 11 through the external speech module 104 and the internal speech module 118. The wireless signal communication module 122 is in signal connection with an app installed on the user's smartphone. The user's smartphone uses the app to deliver voice to the storage module 117 of the latch device 11 and specifies a corresponding one of the sensing cards. When the user corresponding to the sensing card controllably causes the lock module 114 to separate from the door frame 3, the internal speech module 118 of the latch device 11 plays the voice to greet the user entering the door.

When an accident happens, the app sends an alert message to the wireless signal communication module 122 such that the alert message is played by the external speech module 104 and the internal speech module 118 simultaneously to give an alert about the accident.

The panel device 10 further comprises a sensing display screen. The sensing display screen enables the users not carrying the sensing cards to perform the unlocking process with passwords, fingerprints and facial recognition. Furthermore, the wireless update or replacement of display frames of the sensing display screen can be carried out with an app installed on the users'smartphones.

The panel device 10 further comprises an image reading module. The image reading module reads images, such as QR-codes. The user uses an app installed on his or her smartphone to obtain a QR-code. Specifically speaking, the user uses the app to log in a server and request a QR-code, and then the server sends the QR-code to the user's app. Thus, the user allows the obtained QR-code to be read by the image reading module in order to obtain an image signal. Then, the image signal is wirelessly transmitted by the wireless signal transmission module 102 to the wireless signal communication module 122 such that the driving device 12 sends the image signal to the server. Next, the server determines whether the image signal is a correct barcode image or determines whether the barcode image has expired or not. If the image signal is a correct barcode image, the server will send the unlocking trigger signal S1 to the driving device 12; then, the driving control module 121 sends the unlocking trigger signal S1 to the latch control module 111 such that the latch control module 111 generates the control signal S2 that controllably causes the lock module 114 to separate from the door frame 3.

The panel device 10 and the latch device 11 are directly attached to the outer side 21 and the inner side 22 of the door panel 2. The users may purchase and change the panel device 10, the latch device 11, and a casing fitted to the door panel 2.

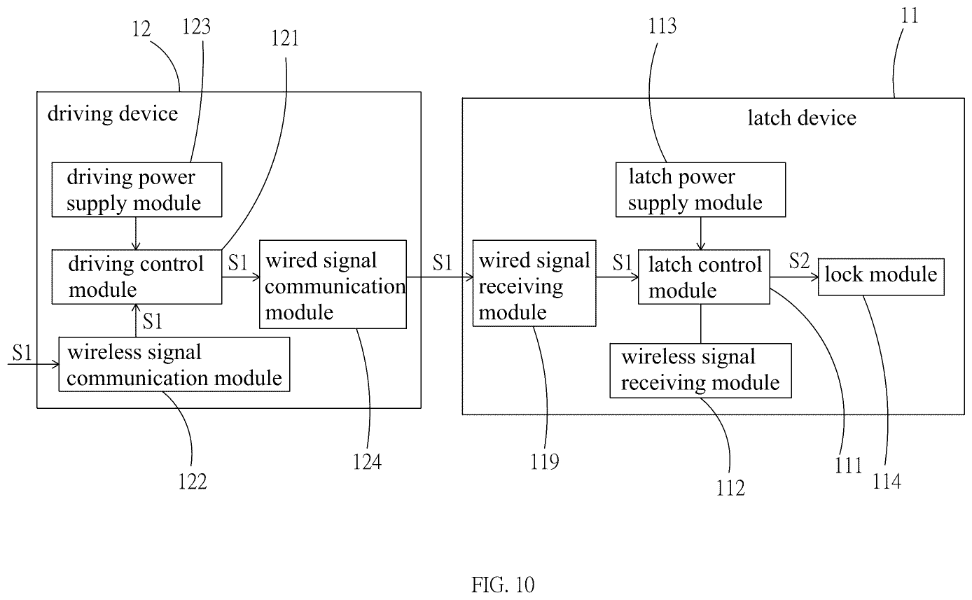

Referring to FIG. 10, there is shown another block diagram of the separate auxiliary digital lock structure of the disclosure. As shown in the diagram, the driving device 12 further comprises a wired signal communication module 124, whereas the latch device 11 further comprises a wired signal receiving module 119. The wired signal communication module 124 and the wired signal receiving module 119 are provided in the form of hardware interfaces, such as USB, for example, Type-C USB. The wired signal communication module 124 is electrically connected to the wired signal receiving module 119 and the driving control module 121. The wired signal communication module 124 is electrically connected to the latch control module 111. The driving control module 121 receives, reads and sends the unlocking trigger signal S1 to the wired signal communication module 124, and then the wired signal communication module 124 sends the unlocking trigger signal S1 to the wired signal receiving module 119. After that, the wired signal receiving module 119 sends the unlocking trigger signal S1 to the latch control module 111 such that the latch control module 111 controllably causes the lock module 114 to separate from the door frame 3.

The disclosure is described above in detail. However, the above description is only based on a preferred embodiment of the disclosure. The embodiment is not restrictive of the scope of the implementation of the disclosure. Thus, all equivalent changes and modifications made to the embodiment according to the claims of the disclosure shall be deemed falling within the scope of the claims of the disclosure.

What is claimed is:

1. A separate auxiliary digital lock structure, adapted to be mounted on a door panel, comprising:
a panel device mounted on an outer side of the door panel and having at least one trigger module and a wireless signal transmission module, the trigger module generating and sending an unlocking trigger signal to the wireless signal transmission module; and
a latch device mounted on an inner side of the door panel and having at least one latch control module, a wireless signal receiving module and a lock module, the wireless signal receiving module receiving and sending the unlocking trigger signal to the latch control module, allowing the latch control module to controllably cause the lock module to separate from a door frame.

2. The separate auxiliary digital lock structure of claim 1, wherein the panel device further comprises a panel power supply module electrically connected to the trigger module.

3. The separate auxiliary digital lock structure of claim 1, wherein the latch device further comprises a latch power supply module electrically connected to the latch control module.

4. The separate auxiliary digital lock structure of claim 1, wherein the latch device further comprises a handle connected to the latch control module, and the latch control module controllably causes the lock module to separate from the door frame.

5. The separate auxiliary digital lock structure of claim 1, wherein the latch device further comprises a sensing module sensing spaced apart from a baffle at a top of the door frame by a distance.

6. The separate auxiliary digital lock structure of claim 1, further comprising a driving device mounted on the inner side of the door panel, the driving device having at least one driving control module and a wireless signal communication module, the wireless signal communication module receiving and sending the unlocking trigger signal to the driving control module, the driving control module receiving, reading and sending the unlocking trigger signal to the wireless signal communication module, the wireless signal communication module sending the unlocking trigger signal to the wireless signal receiving module, the wireless signal receiving module receiving and sending the unlocking trigger signal to the latch control module, allowing the latch control module to controllably cause the lock module to separate from the door frame.

7. The separate auxiliary digital lock structure of claim 6, wherein the driving device further comprises a driving power supply module electrically connected to the driving control module.

8. The separate auxiliary digital lock structure of claim 6, wherein the latch device further comprises a wired signal receiving module in electrical connection with the latch control module, and the driving device further comprises a wired signal communication module in signal electrical connection with the wired signal receiving module and the driving control module, the driving control module receiving, reading and sending the unlocking trigger signal to the wired signal communication module, the wired signal communication module sending the unlocking trigger signal to the wired signal receiving module, the wired signal receiving module receiving and sending the unlocking trigger signal to the latch control module, allowing the latch control module to controllably cause the lock module to separate from the door frame.
